(19) United States
(12) Patent Application Publication
(10) Pub. No.: US 2026/0230396 A1
(43) Pub. Date: Aug. 6, 2026

(54) DEVICES AND METHODS OF COMMUNICATION

(71) Applicant: NEC Corporation, Tokyo (JP)

(72) Inventors: Rao SHI, Beijing (CN); Zhen HE, Beijing (CN); Peng GUAN, Beijing (CN); Wei CHEN, Beijing (CN); You LI, Beijing (CN); Lin LIANG, Beijing (CN); Gang WANG, Beijing (CN)

(73) Assignee: NEC Corporation, Tokyo (JP)

(21) Appl. No.: 19/147,763

(22) PCT Filed: Jan. 17, 2023
(86) PCT No.: PCT/CN2023/072652

§ 371 Date: Jul. 14, 2025

(51) Int. Cl. H04L 41/16; H04L 1/00; H04W 28/02; H04W 72/231; H04W 76/28

(52) U.S. Cl. CPC H04L 41/16; H04L 1/0061; H04W 28/0273; H04W 72/231; H04W 76/28

(57) ABSTRACT

Embodiments of the present disclosure relate to devices and methods of communication. In one aspect, a network device transmits, to a terminal device, a configuration indicating a radio bearer specific to information of an AI model. The terminal device performs transmission or reception of the information of the AI model on the radio bearer. In this way, delivery of AI model information in CP or UP may be enhanced.

### TECHNICAL FIELD

Embodiments of the present disclosure generally relate to the field of telecommunication, and in particular, to devices and methods of communication for delivery of artificial intelligence (AI) model information.

### BACKGROUND

Recently, it is agreed to study control plane (CP)-based and user plane (UP)-based solutions for AI model delivery. Conventional CP-based and UP-based solutions may be not enough for AI model delivery due to a large size of AI model information or complexity of delivery of AI model information generated at an access network device. Thus, the CP-based and UP-based solutions need to be enhanced for AI model delivery.

### SUMMARY

In general, embodiments of the present disclosure provide methods, devices and computer storage media of communication for delivery of AI model information.

In a first aspect, there is provided a terminal device. The terminal device comprises a processor. The processor is configured to cause the terminal device to: receive, from a network device, a configuration indicating a radio bearer specific to information of an AI model; and perform transmission or reception of the information of the AI model on the radio bearer.

In a second aspect, there is provided a terminal device. The terminal device comprises a processor. The processor is configured to cause the terminal device to: determine one of a CP based scheme and a UP based scheme for transmission or reception of information of an AI model; and perform the transmission or reception of the information of the AI model based on the determined one of the CP based scheme and the UP based scheme.

In a third aspect, there is provided a terminal device. The terminal device comprises a processor. The processor is configured to cause the terminal device to: receive, from a network device, a discontinuous reception (DRX) configuration specific to information of an AI model; and perform, based on the DRX configuration, physical downlink control channel (PDCCH) monitoring for reception of the information of the AI model.

In a fourth aspect, there is provided a method of communication. The method comprises: receiving, at a terminal device and from a network device, a configuration indicating a radio bearer specific to information of an AI model; and performing transmission or reception of the information of the AI model on the radio bearer.

In a fifth aspect, there is provided a method of communication. The method comprises: determining, at a terminal device, one of a CP based scheme and a UP based scheme for transmission or reception of information of an AI model; and performing the transmission or reception of the information of the AI model based on the determined one of the CP based scheme and the UP based scheme.

In a sixth aspect, there is provided a method of communication. The method comprises: receiving, at a terminal device and from a network device, a DRX configuration specific to information of an AI model; and performing, based on the DRX configuration, PDCCH monitoring for reception of the information of the AI model.

In a seventh aspect, there is provided a computer readable medium having instructions stored thereon. The instructions, when executed on at least one processor, cause the at least one processor to perform the method according to any of the fourth to sixth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2A illustrates a schematic diagram of a radio access network (RAN)-based CP solution in which some embodiments of the present disclosure can be implemented;

FIG. 2B illustrates a schematic diagram of a core network (CN)-based CP solution in which some embodiments of the present disclosure can be implemented;

FIG. 2C illustrates a schematic diagram of a CN-based UP solution in which some embodiments of the present disclosure can be implemented;

FIG. 2D illustrates a schematic diagram of an RAN-based UP solution in which some embodiments of the present disclosure can be implemented;

FIG. 3 illustrates a schematic diagram illustrating a process of communication for AI model information delivery according to embodiments of the present disclosure;

FIG. 4 illustrates a schematic diagram illustrating a process of communication for determination of an AI model information delivery scheme according to embodiments of the present disclosure;

FIG. 5 illustrates a schematic diagram illustrating a process of communication for DRX of AI model information according to embodiments of the present disclosure;

FIG. 6 illustrates a schematic diagram illustrating an example DRX function according to embodiments of the present disclosure;

FIG. 7 illustrates an example method of communication implemented at a terminal device in accordance with some embodiments of the present disclosure;

FIG. 8 illustrates another example method of communication implemented at a terminal device in accordance with some embodiments of the present disclosure;

FIG. 9 illustrates still another example method of communication implemented at a terminal device in accordance with some embodiments of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” may refer to a device which is capable of providing or hosting a cell or coverage where terminal devices can communicate. Examples of an access network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have AI or machine learning (ML) capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “AI model” may be interchangeably used with “ML model”. The term “delivery of AI model information” may be interchangeably used with “transfer of AI model information”.

Conventionally, as a size of AI model or a data set for the AI model may be large, a CP-based solution may be not enough or reliable for such huge data transfer. In case that radio resource control (RRC) segments are used to transfer AI model information, if any one of the RRC segments is missed, the whole RRC reception or transmission may be failed.

Furthermore, only a user plane function (UPF) establishes a protocol data unit (PDU) session, and traffic data is transferred on a data radio bearer (DRB). That means an access network device cannot generate traffic data by itself via a DRB. In this case, if AI model information is generated by an access network device, how the access network device transfers the AI model information becomes an issue.

In addition, continuously huge data transfer for AI model information may impact a normal DRX function (e.g., always active-time-on), and may increase PDCCH blind detection by a terminal device.

In view of this, embodiments of the present disclosure provide solutions for delivery of AI model information. In one solution, a terminal device receives, from a network device, a configuration indicating a radio bearer specific to information of an AI model, and performs transmission or reception of the information of the AI model on the radio bearer. In this way, a CP-based or UP-based solution may be enhanced to be applicable to delivery of AI model information.

In another solution, a terminal device determines one of a CP based scheme and a UP based scheme for transmission or reception of information of an AI model, and performs the transmission or reception of the information of the AI model based on the determined one of the CP based scheme and the UP based scheme. In this way, a scheme for delivery of AI model information may be determined.

In still another solution, a terminal device receives, from a network device, a DRX configuration specific to information of an AI model, and performs, based on the DRX configuration, PDCCH monitoring for reception of the information of the AI model. In this way, unnecessary PDCCH blind detection may be avoided.

Principles and implementations of the present disclosure will be described in detail below with reference to the figures.

### Example of Communication Network

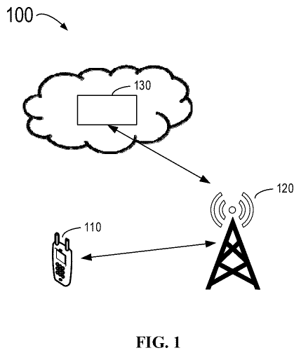

FIG. 1 illustrates a schematic diagram of an example communication network 100 in which some embodiments of the present disclosure can be implemented. As shown in FIG. 1, the communication network 100 may include terminal device 110 and a network device 120 in RAN. In some embodiments, the network device 120 may provide one or more serving cells (not shown) to serve the terminal device 110.

As shown in FIG. 1, the communication network 100 may further include a CN element 130 in CN. In some embodiments, the network device 120 may communicate with the CN element 130. The CN element may refer to any device or entity that provides access and mobility management function (AMF), network exposure function (NEF), authentication server function (AUSF), unified data management (UDM), session management function (SMF), UPF, a location management function (LMF), etc. In other embodiments, the CN element may be any other suitable device or entity providing any other suitable functionality.

Although not shown, the communication network 100 may further include other network elements such as Operation, Administration, and Maintenance (OAM).

It is to be understood that the number of devices in FIG. 1 is given for the purpose of illustration without suggesting any limitations to the present disclosure. The communication network 100 may include any suitable number of network devices and/or terminal devices and/or CN elements and/or other components adapted for implementing implementations of the present disclosure.

The terminal device 110 may communicate with the network device 120 via a Uu interface. The network device 120 may communicate with the CN element 130 via an Ng interface. The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

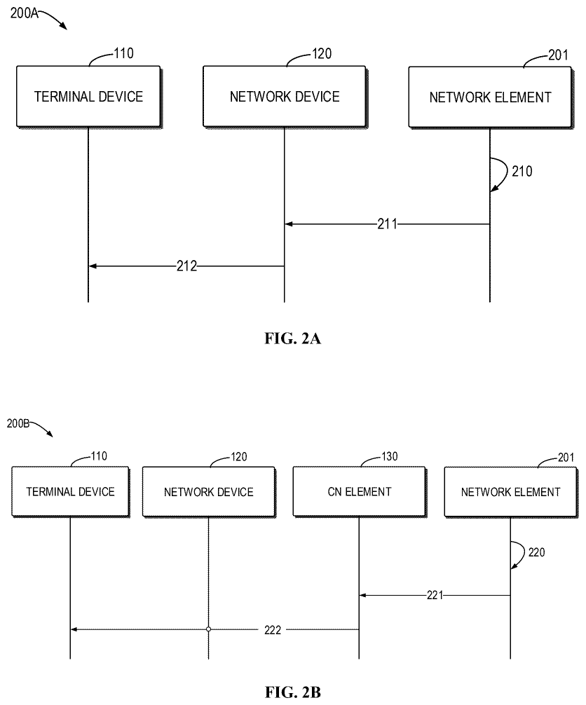

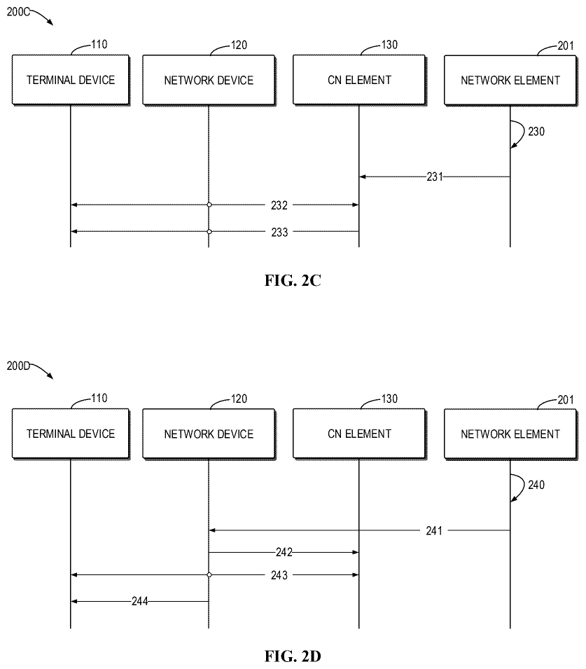

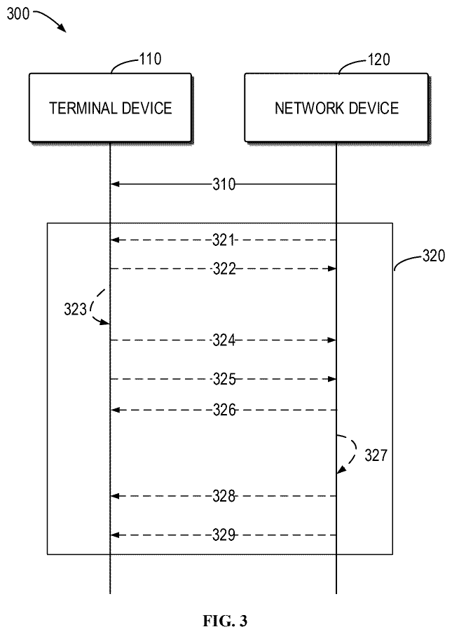

FIG. 2A illustrates a schematic diagram 200A of an RAN-based CP solution in which some embodiments of the present disclosure can be implemented. For the purpose of discussion, the process 200A will be described with reference to FIG. 1. As shown in FIG. 2A, a network element 201 such as the network device 120 or the CN element 130 or OAM may generate 210 an AI model. The network element may perform 211 a model delivery to the network device 120. The network device 120 may perform 212 a model transfer to the terminal device 110 on a signal radio bearer (SRB). This is an RAN-based CP solution.

FIG. 2B illustrates a schematic diagram 200B of a CN-based CP solution in which some embodiments of the present disclosure can be implemented. For the purpose of discussion, the process 200B will be described with reference to FIG. 1. As shown in FIG. 2B, a network element 201 such as the network device 120 or the CN element 130 or OAM may generate 220 an AI model. The network element may perform 221 model delivery to the CN element 130. The CN element 130 may perform 222 model transfer to the terminal device 110 on a SRB via the network device 120. This is a CN-based CP solution.

FIG. 2C illustrates a schematic diagram 200C of a CN-based UP solution in which some embodiments of the present disclosure can be implemented. For the purpose of discussion, the process 200C will be described with reference to FIG. 1. As shown in FIG. 2C, a network element 201 such as the network device 120 or the CN element 130 or OAM may generate 230 an AI model. The network element may perform 231 a model delivery to the CN element 130. The CN element 130 may establish 232 a PDU session with the terminal device 110 for transmission of model information. Then the CN element 130 may perform 233 a model transfer to the terminal device 110 on a data radio bearer (DRB) for the PDU session. This is a CN-based UP solution.

FIG. 2D illustrates a schematic diagram 200D of an RAN-based UP solution in which some embodiments of the present disclosure can be implemented. For the purpose of discussion, the process 200D will be described with reference to FIG. 1. As shown in FIG. 2D, a network element 201 such as the network device 120 or the CN element 130 or OAM may generate 240 an AI model. The network element may perform 241 a model delivery to the network device 120. The network device 120 may request 242 the CN element 130 to setup a PDU session. The CN element 130 may establish 243 the PDU session for transmission of model information. Then the network device 130 may perform 244 a model transfer to the terminal device 110 via a DRB for the PDU session. This is an RAN-based UP solution.

Embodiments of the present disclosure provide solutions for delivery of AI model information so as to achieve efficient delivery of AI model information. More details will be described in connection with FIGS. 3 to 5 below.

In the context of the present disclosure, the term “AI model information” may be interchangeably used with “information of an AI model”, and may refer to an AI model (e.g., parameters of the AI model) or a data set for the AI model.

### Example Implementation of AI Model Information Delivery

FIG. 3 illustrates a schematic diagram illustrating a process 300 of communication for AI model information delivery according to embodiments of the present disclosure. For the purpose of discussion, the process 300 will be described with reference to FIG. 1. The process 300 may involve the terminal device 110 and the network device 120 as illustrated in FIG. 1. It is to be understood that the steps and the order of the steps in FIG. 3 are merely for illustration, and not for limitation. For example, the order of the steps may be changed. Some of the steps may be omitted or any other suitable additional steps may be added.

As shown in FIG. 3, the network device 120 may transmit 310, to the terminal device 110, a configuration indicating a radio bearer specific to information of an AI model. In some embodiments, the radio bear may be associated with an identity (ID) of the AI model. In some embodiments, the radio bear may be associated with a function of the AI model. In some embodiments, the radio bear may be associated with an ID of a data set for the AI model. It is to be understood that the radio bearer may be associated with any combination of the above information.

In some embodiments, the radio bearer may be a SRB or an AI radio bearer (ARB). In the context of the present disclosure, the term “ARB” refers to a radio bearer dedicated for carrying AI model information. The ARB may carry CP data of AI model information, and also may carry UP data of AI model information. For example, the SRB or ARB may be configured as below.

| | |
|---|---|
| SRB/ARB-ToAddMod ::= | SEQUENCE { |
| srb/arb-Identity | SRB/ARB-Identity, |
| modelIdentification | Model-ID, |
| modelFunction | ENUMERATED{CSI- Compression, |
| | CSI-prediction, BeamManagement, |
| | positioning}, |
| modelDataSetIdentification | DataSet-ID, |
| reestablishPDCP | ENUMERATED{true}, |
| discardOnPDCP | ENUMERATED{true}, |
| pdcp-Config | PDCP-Config, |

...,
}

In this example, an information element (IE) “SRB/ARB” refers to a signal radio bearer used for an RRC message or non-access stratum (NAS) signaling which includes AI model delivery. An IE “modelIdentification” is used to identify an AI model. An IE “modelFunction” indicates which AI function the model delivery is used for. An IE “modelDataSetIdentification” is used to identify a set of AI data. It is to be understood that this is merely for illustration, and is not intended for limitation.

In some embodiments, the radio bearer may be a DRB or ARB. In some embodiments, the configuration may further comprise an indication whether the radio bearer is used for transmission or reception of the information of the AI model associated with a RAN. The indication may be an explicit indication. Of course, an implicit indication may also be feasible. In some embodiments, presence or absence of a service data adaptation protocol (SDAP) configuration may be used as the implicit indication. For example, the DRB may be configured as below.

| | |
|---|---|
| DRB/ARB-ToAddMod ::= | SEQUENCE { |
| drb/arb-Identity | DRB/ARB-Identity, |
| modelIdentification | Model-ID, |
| modelFunction | ENUMERATED{CSI- Compression, |
| | CSI-prediction, BeamManagement, |
| | positioning}, |
| modelDataSetIdentification | DataSet-ID, |
| (Opt.1)noCNAssociation | ENUMERATED{true} |
| (Opt.2)sdap-Config | SDAP-Config OPTIONAL, -- |
| | Cond DRB/ARBfofCN |
| reestablishPDCP | ENUMERATED{true} |
| discardOnPDCP | ENUMERATED{true} |
| pdcp-Config | PDCP-Config, |

```
  ...,
  [[
```

| | |
|---|---|
| daps-Config-r [symbol] | ENUMERATED{true} |

]]
} [symbol]
indicates data missing or illegible when filed

In this example, an IE “DRB/ARB” refers to a data radio bearer used for traffic data delivery which includes AI model information. An IE “modelIdentification” is used to identify an AI model. An IE “modelFunction” indicates which AI function the model delivery is used for. An IE “modelDataSetIdentification” is used to identify a set of AI data.

As an option (Opt.1), an IE “noCNAssociation” may be introduced. The presence of the IE “noCNAssociation” or the IE “noCNAssociation” configured with true may indicate that the radio bearer is not required to be associated with a PDU session ID, and the traffic data on the radio bearer is served by a network device itself. That is, the traffic data is not associated with a UPF entity of CN and is not associated with a SDAP entity.

As another option (Opt.2), the presence of an IE “sdap-Config” (that is used to be associated with a PDU session ID from CN) may indicate the traffic data on the radio bearer is associated with CN, and the absence of the IE “sdap-Config” may indicate the traffic data on the radio bearer is directly served by a network device itself.

It is to be understood that this is merely for illustration, and is not intended for limitation. In some embodiments, instead of DRB or ARB, a multicast broadcast service (MBS) radio bearer (MRB) may also be used for delivery of AI model information. In this case, the AI model information is applied for multiple terminal devices. Opt.1 and Opt.2 may also be applied for the MRB except that MRB's SDAP configuration may comprise empty content.

Continue to refer to FIG. 3, upon reception of the configuration of the radio bearer, the terminal device 110 may perform 320 transmission or reception of the information of AI model on the radio bearer. For illustration, some example embodiments will be detailed in connection with Embodiments 1 to 3 below.

### Embodiment 1

In this embodiment, the radio bearer is a SRB or ARB, and a downlink (DL) transmission of the information of AI model is performed on the SRB or ARB.

Continue to refer to FIG. 3, the terminal device 110 may receive 321, from the network device 120, a message (for convenience, also referred to as a first message herein) comprising a segment (for convenience, also referred to as a first segment herein) of the information of the AI model.

In some embodiments, the first message may be associated with an ID of the AI model. In some embodiments, the first message may be associated with a function of the AI model. In some embodiments, the first message may be associated with an ID of a data set for the AI model. It is to be understood that the first message may be associated with any combination of the above information.

For example, an example procedure may be described as below:

When CN/gNB needs to transfer AI model to UE, the gNB will establish SRBX or ARB for model transfer, and it also indicates which model is to be transferred by associated model ID/function and which data set is to be transferred by associated data set ID.

Alternatively, the IE—model ID, function and data set ID could also be included in the dedicated RRC message used to transfer model/data instead of within a dedicated radio bearer.

In some embodiments, the first message may be configured as below:

| | |
|---|---|
| DLDedicatedMessageSegment-IEs ::= | SEQUENCE { |
| segmentNumber | INTEGER(0..15..X), |
| requestForConfirmation | ENUMERATED {true}, |
| transferredModelSize | XXX, |
| rrc-MessageSegmentContainer | OCTET STRING |
| rrc-MessageSegmentType | ENUMERATED |
| | {noLastSegment, |
| | lastSegment}, |
| lateNonCriticalExtension | OCTET STRING |
| nonCritialExtension | SEQUENCE { } |

}

In this example, an IE “segmentNumber” indicates a sequence number of a current segment of the whole RRC message. The IE “segmentNumber” may be extended to any integers greater than 4, for example, 7 or 15 or 31. In this way, delivery of AI model information may be facilitated.

An IE “requestForConfirmation” may be introduced. The presence of the IE “requestForConfirmation” or the IE “requestForConfirmation” configured with true may indicate that a network device is expecting the confirmation from a terminal device that the terminal device has successfully received the current and previous RRC segments. In this case, the terminal device shall respond to the network device for the reception of segments.

An IE “transferredModelSize” may be introduced. The IE “transferredModelSize” indicates a size of a transferred portion of the AI model information. For example, when a network device is requesting the confirmation for the reception of segments, a model size that is already transferred may be comprised. A reasonable unit of the model size may be a bit or byte. The IE “transferredModelSize” may be considered as assistance information for a terminal device to check the situation of model transfer.

Continue to refer to FIG. 3, if the first message comprises a request for confirmation for reception of the first segment (e.g., the IE “requestForConfirmation” is configured with true), the terminal device 110 may transmit 322, to the network device 120, an indication (for convenience, also referred to as a first indication herein) that the first segment has been received.

In some embodiments, the first indication may be carried by an RRC message. In some embodiments, the first indication may be carried by a medium access control control element (MAC CE). In some embodiments, the first indication may be carried by uplink control information (UCI).

In some embodiments, the first indication may comprise a sequence number of the first segment. In some embodiments, the first indication may comprise a size of a transferred portion of the information of the AI model.

In this way, subsequent segments may also be transferred and confirmed.

Continue to refer to FIG. 3, based on a sequence number of the first segment currently received and a sequence number of a segment (for convenience, also referred to as a second segment herein) previously received, the terminal device 110 may determine 323 that another segment (for convenience, also referred to as a third segment herein) is missing. In other words, the segments are out of order. In this case, the terminal device 110 may transmit 324, to the network device 120, an indication (for convenience, also referred to as a second indication herein) that the third segment is missing. In some embodiments, the second indication may comprise a sequence number of the third segment.

In some embodiments, the second indication may be carried by an RRC message. In some embodiments, the second indication may be carried by a MAC CE. In some embodiments, the second indication may be carried by UCI.

For illustration, an example procedure may be described as below.

### Initiation

The network initiates the DL Dedicated Message Segment transfer procedure whenever the encoded RRC message PDU exceeds the maximum PDCP SDU size, e.g., for AI model transfer/delivery, AI data set transfer/delivery. The network initiates the DL Dedicated Message Segment transfer procedure by sending the DLDedicatedMessageSegment message.

### Reception of DLDedicatedMessageSegment by the UE

Upon receiving DLDedicatedMessageSegment message, the UE shall:

```
  1> store the segment included in rrc-MessageSegmentContainer;
  1> if requestForConfirmation is included in DLDedicatedMessageSegment:
    2> include the currently received segmentNumber in RRC message / MAC CE
/ UCI for transmission to network (includes RRC/MAC/PHY operate);
  1> if receives the DLDedicatedMessageSegment of which the segmentNumber is
not in a correct order compared to the last received segmentNumber:
    2> include the missing segmentNumber between the last received
segmentNumber and the currently received segmentNumber in RRC message / MAC CE /
UCI for transmission to network (includes RRC/MAC/PHY operate);
  1> if all segments of the message have been received:
    2> assemble the message from the received segments and process the message
for the RRCReconfiguration message or for the RRCResume message or for AI model
transfer/delivery or for AI data set transfer/delivery;
    2> discard all segments.
```

In this way, DL segment transmission in CP may be achieved.

### Embodiment 2

In this embodiment, the radio bearer is a SRB or ARB, and an uplink (UL) transmission of the information of AI model is performed on the SRB or ARB.

Continue to refer to FIG. 3, the terminal device 110 may transmit 325, to the network device 120, a message (for convenience, also referred to as a second message herein) comprising a segment (for convenience, also referred to as a fourth segment herein) of the information of the AI model.

In some embodiments, the second message may be associated with an ID of the AI model. In some embodiments, the second message may be associated with a function of the AI model. In some embodiments, the second message may be associated with an ID of a data set for the AI model. It is to be understood that the second message may be associated with any combination of the above information.

For example, an example procedure may be described as below:

When UE needs to transfer AI model to CN/gNB, the gNB will establish SRBX or ARB for model transfer, and it also indicates which model is to be transferred by associated model ID/function and which data set is to be transferred by associated data set ID.

Alternatively, the IE—model ID, function and data set ID could also be included in the dedicated RRC message used to transfer model/data instead of within a dedicated radio bearer.

In some embodiments, the second message may be configured as below:

| | |
|---|---|
| ULDedicatedMessageSegment-IEs ::= | SEQUENCE { |
| segmentNumber | INTEGER (0..31..X), |
| requestForConfirmation | ENUMERATED {true}, |
| transferredModelSize | XXX, |
| rrc-MessageSegmentContainer | OCTET STRING |
| rrc-MessageSegmentType | ENUMERATED |
| | {noLastSegment, |
| | lastSegment}, |
| lateNonCriticalExtension | OCTET STRING |
| nonCritialExtension | SEQUENCE { } |

}

In this example, an IE “segmentNumber” indicates a sequence number of a current segment of the whole RRC message. The IE “segmentNumber” may be extended to any integers greater than 15, for example, 31 or 63. In this way, delivery of AI model information may be facilitated.

An IE “requestForConfirmation” may be introduced. The presence of the IE “requestForConfirmation” or the IE “requestForConfirmation” configured with true may indicate that a terminal device is expecting the confirmation from a network device that the network device has successfully received the current and previous RRC segments. In this case, the network device shall respond to the terminal device for the reception of segments.

An IE “transferredModelSize” may be introduced. The IE “transferredModelSize” indicates a size of a transferred portion of the AI model information. For example, when a terminal device is requesting the confirmation for the reception of segments, a model size that is already transferred may be comprised. A reasonable unit of the model size may be a bit or byte.

Continue to refer to FIG. 3, if the second message comprises a request for confirmation for reception of the fourth segment (e.g., the IE “requestForConfirmation” is configured with true), the terminal device 110 may receive 326, from the network device 120, an indication (for convenience, also referred to as a third indication herein) that the fourth segment has been received.

In some embodiments, the third indication may be carried by an RRC message. In some embodiments, the third indication may be carried by a MAC CE. In some embodiments, the third indication may be carried by DCI.

In some embodiments, the third indication may comprise a sequence number of the fourth segment. In some embodiments, the third indication may comprise a size of a transferred portion of the information of the AI model.

In some embodiments, if the second message is transmitted, the terminal device 110 may start a timer. In some embodiments, if the third indication is received, the terminal device 110 may stop the timer. In some embodiments, if the timer expiries, the terminal device 110 may stop transmission of the information of the AI model.

In this way, subsequent segments may also be transferred and confirmed.

Continue to refer to FIG. 3, based on a sequence number of the fourth segment currently received and a sequence number of a segment previously received, the network device 120 may determine 327 that another segment (for convenience, also referred to as a fifth segment herein) is missing. In other words, the segments are out of order. In this case, the network device 120 may transmit 328, to the terminal device 110, an indication (for convenience, also referred to as a fourth indication herein) that the fifth segment is missing. In some embodiments, the fourth indication may comprise a sequence number of the fifth segment.

In some embodiments, the fourth indication may be carried by an RRC message. In some embodiments, the fourth indication may be carried by a MAC CE. In some embodiments, the fourth indication may be carried by DCI.

For illustration, an example procedure may be described as below.

### Actions Related to Transmission of ULDedicatedMessageSegment Message

The UE shall segment the encoded RRC PDU based on the maximum supported size of a PDCP SDU. UE shall minimize the number of segments and set the contents of the ULDedicatedMessageSegment messages as follows:

```
  1> For each new UL DCCH message, set the segmentNumber to 0 for the first
message segment and increment the segmentNumber for each subsequent RRC message
segment;
  1> set rrc-MessageSegmentContainer to include the segment of the UL DCCH
message corresponding to the segmentNumber;
  1 > if the UE is expecting the confirmation from network that the network has
successfully received the current and previous RRC segment:
    2> include the requestForConfirmation in ULDedicatedMessageSegment;
    2> include the transferredModelSize in ULDedicatedMessageSegment;
    2> suspend the transmission of ULDedicatedMessageSegment corresponding to
the subsequent segmentNumber;
    2> start the Responsetimer;
  1> if receives the confirmation carrying the segmentNumber corresponding to the last
transmitted segmentNumber:
    2> continue / recover the transmission of ULDedicatedMessageSegment
corresponding to the subsequent segmentNumber;
    2> stop the Responsetimer;
  1> if the ResponseTimer expires (i.e., no response received):
    2> the procedure is ended;
  1> if receives the indication of missing segmentNumber by RRC / MAC CE / DCI:
    2> retransmit the ULDedicatedMessageSegment corresponding to the missing
segmentNumber;
  1> if the segment included in the rrc-MessageSegmentContainer is the last segment of
the UL DCCH message:
    2> set the rrc-MessageSegmentType to lastSegment;
  1> else:
    2> set the rrc-MessageSegmentType to notLastSegment;
  1> submit all the ULDedicatedMessageSegment messages generated for the
segmented RRC message to lower layers for transmission in ascending order based on the
segmentNumber, upon which the procedure ends.
```

In this way, UL segment transmission in CP may be achieved.

### Embodiment 3

In this embodiment, the radio bearer is a DRB or ARB or MRB, and a DL or UL transmission of the information of AI model is performed on the DRB or ARB or MRB.

Continue to refer to FIG. 3, the terminal device 110 may receive 329, from the network device 120, an indication that the DRB is used for transmission or reception of the information of the AI model associated with a RAN. In this way, the terminal device 110 may transmit information of an AI model to the network device 120 or receive information of an AI model from the network device 120 via the DRB.

In some embodiments, if a SDAP configuration is absent, the terminal device 110 may determine that the radio bearer is used for transmission or reception of the information of the AI model associated with the RAN. If the SDAP configuration is present or the SDAP configuration is empty, the terminal device 110 may determine that the radio bearer is used for transmission or reception of the information of the AI model associated with a CN.

For illustration, an example procedure may be described as below.

### DRB/ARB/MRB Addition/Modification

The UE shall:

```
  1> for each drb/arb-Identity value included in the drb/arb/mrb-ToAddModList:
    2> if the modelIdentification is included:
      3> associate the established DRB/ARB with corresponding AI model
transfer/delivery, and Model-ID is used for identifying this AI model;
    2> if the modelFunction is included:
      3> associate the established DRB/ARB with corresponding AI function
indicated by modelFunction;
    2> if the modelDataSetIdentification is included:
      3> associate the established DRB/ARB with corresponding AI data set
indicated by DataSet-ID;
    2> if the noCNAssociation is included /configured with true:
      3> acknowledge the established DRB/ARB is used for the traffic data served
for gNB itself, i.e., the UE is not required to associate this established DRB/ARB with a
(PDU) session id (no CN − UPF entity involved) or is not required to configure the SDAP
entity;
    2> else:
      3> configure the SDAP entity in accordance with the received sdap-Config
and associate the DRB/ARB with the SDAP entity (i.e., associate with a PDU session id
and involve CN − UPF entity);
    2> if the sdap-Config is included:
      3> configure the SDAP entity in accordance with the received sdap-Config
and associate the DRB/ARB with the SDAP entity (i.e., associate with a PDU session id
and involve CN − UPF entity);
    2> else:
      3> acknowledge the established DRB/ARB is used for the traffic data served
for gNB itself, i.e., the UE is not required to associate this established DRB/ARB with a
(PDU) session id (no CN − UPF entity involved).
```

In this way, UL and DL transmission in UP may be achieved.

With the process 300, delivery of AI model information may be carried out.

### Example Implementation of Determination of Delivery Scheme

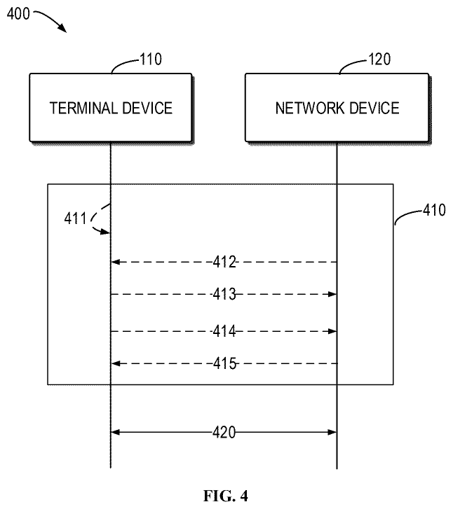

FIG. 4 illustrates a schematic diagram illustrating a process 400 of communication for determination of an AI model information delivery scheme according to embodiments of the present disclosure. For the purpose of discussion, the process 400 will be described with reference to FIG. 1. The process 400 may involve the terminal device 110 and the network device 120 as illustrated in FIG. 1. It is to be understood that the steps and the order of the steps in FIG. 4 are merely for illustration, and not for limitation. For example, the order of the steps may be changed. Some of the steps may be omitted or any other suitable additional steps may be added.

As shown in FIG. 4, the terminal device 110 may determine 410 one of a CP based scheme and an UP based scheme for transmission or reception of information of an AI model.

In some embodiments, the terminal device 110 may determine 411 one of the CP based scheme and the UP based scheme based on a criteria. In some embodiments, if a size of the information of the AI model is above a threshold size, the terminal device 110 may select the UP based scheme for transmission of the information of the AI model. If the size of the information of the AI model is below the threshold size, the terminal device 110 may select the CP based scheme for transmission of the information of the AI model. In some embodiments, if a number of parameters for the AI model is above a threshold number, the terminal device 110 may select the UP based scheme for transmission of the information of the AI model. In some embodiments, if the number of parameters for the AI model is below the threshold number, the terminal device 110 may select the CP based scheme for transmission of the information of the AI model. In some embodiments, the terminal device 110 may select, from a mapping between functions of AI models and schemes, the one of the CP based scheme and the UP based scheme corresponding to a function of the AI model.

For illustration, an example procedure may be described as below:

The purpose of this procedure is to determine the method of AI model, data set transfer/delivery, e.g., CP method or UP method.

The UE may determine AI model transfer method based on the following criteria:

```
  1> if the size of AI model need to be transferred is greater than the value of
threshold_ModelSize:
    2> select the UP method to transfer the AI model, i.e., UE request a
DRB/ABR/MRB establishment;
  1> else:
    2> select the CP method to transfer the AI model, i.e., UE request a SRBx/ARB
establishment;
  1> if the number of parameters is greater than the value of threshold_NofPara:
    2> select the UP method to transfer the AI model, i.e., UE request a
DRB/ABR/MRB establishment;
  1> else:
    2> select the UP method to transfer the AI model, i.e., UE request a SRBx/ARB
establishment;
  1> if the mapping relationship between AI model function and transfer method is
available:
    2> determine UP or CP method based on the mapping_ModelFunctionList.
```

In some embodiments for DL reception of the AI model information, the network device 120 may transmit 412, to the terminal device 110, a message for enquiring whether a CP based scheme or a UP based scheme is used for transmission of the information of the AI model. In some embodiments, the message may be an RRC message. In some embodiments, the message may be a MAC CE. In some embodiments, the message may be DCI. In some embodiments, the message may be UE capabilities message.

In some embodiments, the message may comprise a size of the information of the AI model. For example, the message may comprise a size of the AI model or a size of a data set for the AI model. In some embodiments, the message may comprise a number of parameters for the AI model. In some embodiments, the message may comprise a mapping between functions of AI models and schemes. In some embodiments, the message may comprise an expected scheme for transmission of the information of the AI model. In some embodiments, the message may comprise a priority of the information of the AI model. For example, the message may comprise a priority of the AI model or the data set for the AI model. In some embodiments, the message may comprise latency of the transmission of the information of the AI model. In some embodiments, the message may comprise a number of AI models.

In response to the enquiring message, the terminal device 110 may transmit 413, to the network device 120, information of the determined one of the CP based scheme and the UP based scheme.

For illustration, an example procedure may be described as below:

The purpose of this procedure is to determine the method of AI model, data set transfer/delivery, e.g., CP method or UP method.

The gNB/CN may initiate the AIModelTransferEnquiry to a UE to enquiry the specific method used as AI model, data set transfer delivery.

Upon the reception of AIModelTransferEnquiry, the UE shall:

```
  1> if the AI model size is included:
    2> if the size of AI model is greater than the value of threshold_ModelSize:
      3> include UP method notification in AIModelTransferInformation for
transmission to network;
    2> else:
      3> include CP method notification in AIModelTransferInformation for
transmission to network;
  1> if the number of parameters is included:
    2> if the number of parameters is greater than the value of threshold_NofPara:
      3> include UP method notification in AIModelTransferInformation for
transmission to network;
    2> else:
      3> include CP method notification in AIModelTransferInformation for
transmission to network;
  1> if the mapping relationship between AI model function and transfer method is
included:
    2> include UP or CP method based on the mapping_ModelFunctionList in
AIModelTransferInformation for transmission to network;
  1> if the specific transfer method for model transfer is included:
    2> the UE may include the corresponding transfer method (e.g., based on UE
implementation) in AIModelTransferInformation for transmission to network.
  1> if the specific transfer method for data set is included:
    2> the UE may include the corresponding transfer method (e.g., based on UE
implementation) in AIModelTransferInformation for transmission to network.
```

It is to be understood that, except the above information, a terminal device may determine a delivery scheme based on other assistance information sent from a network device, e.g., model priority, model transfer latency, or number of models.

In some embodiments for UL transmission of the AI model information, the terminal device 110 may transmit 414, to the network device 120, a message for enquiring whether a CP based scheme or a UP based scheme is used for transmission of the information of the AI model.

In some embodiments, the message may comprise a size of the information of the AI model. For example, the message may comprise a size of the AI model or a size of a data set for the AI model. In some embodiments, the message may comprise a number of parameters for the AI model. In some embodiments, the message may comprise a mapping between functions of AI models and schemes. In some embodiments, the message may comprise an expected scheme for transmission of the information of the AI model. In some embodiments, the message may comprise a priority of the information of the AI model. For example, the message may comprise a priority of the AI model or the data set for the AI model. In some embodiments, the message may comprise latency of the transmission of the information of the AI model. In some embodiments, the message may comprise a number of AI models.

Then the terminal device 110 may receive 415, from the network device 120, information of the determined one of the CP based scheme and the UP based scheme.

For illustration, an example procedure may be described as below:

The purpose of this procedure is to determine the method of AI model, data set transfer/delivery, e.g., CP method or UP method.

The UE may initiate the AIModelTransferEnquiry to gNB/CN to enquiry the specific method used as AI model, data set transfer.

Upon the initiation of AIModelTransferEnquiry, the UE shall:

```
  1> include the size of AI model in AIModelTransferEnquiry;
  1> include the number of parameters in AIModelTransferEnquiry;
  1> include the AI model function (e.g., CSI compression / CSI prediction/ beam
management / positioning) in AIModelTransferEnquiry:
  1> include the expected transfer method for model (if UE expects) in
AIModelTransferEnquiry;
  1> include the expected transfer method for data set (if UE expects) in
AIModelTransferEnquiry;
  1> include the model priority in AIModelTransferEnquiry;
  1> include the model transfer latency in AIModelTransferEnquiry;
  1> include the number of AI models need to be transferred in
AIModelTransferEnquiry;
  1> submit the AIModelTransferEnquiry message to lower layer for transmission to
gNB/CN.
```

Generally, after the reception of AIModelTransferInformation, if CP method is selected, UE may wait for receiving RRC message for AI model transfer/delivery. If UP method is selected, UE may be configured by network with a radio bearer (e.g., DRB/ARB) used to transmit traffic data for AI model information.

Continue to refer to FIG. 4, upon determining the one of the CP based scheme and the UP based scheme, the terminal device 110 may perform 420 the transmission or reception of the information of the AI model based on the determined one of the CP based scheme and the UP based scheme.

With the process 400, an AI model information delivery scheme may be selected.

### Example Implementation of DRX of AI Model Information

FIG. 5 illustrates a schematic diagram illustrating a process 500 of communication for DRX of AI model information according to embodiments of the present disclosure. For the purpose of discussion, the process 500 will be described with reference to FIG. 1. The process 500 may involve the terminal device 110 and the network device 120 as illustrated in FIG. 1. It is to be understood that the steps and the order of the steps in FIG. 5 are merely for illustration, and not for limitation. For example, the order of the steps may be changed. Some of the steps may be omitted or any other suitable additional steps may be added.

As shown in FIG. 5, the network device 120 may transmit 510, to the terminal device 110, a DRX configuration specific to information of an AI model. In other words, a DRX function specific to AI model information is introduced.

During active time in conventional DRX function, a terminal device may monitor PDCCH with various radio network temporary identities (RNTIs). By adding the DRX function specific to AI model information, the conventional DRX function and the DRX function specific to AI model information may run independently or simultaneously.

In some embodiments, the DRX configuration specific to information of an AI model may comprise the following parameters:
drx-onDurationTimerAI: the duration at the beginning of a DRX cycle;
drx-SlotOffsetAI: the delay before starting the drx-onDurationTimerAI;
drx-InactivityTimerAI: the duration after the PDCCH occasion in which a PDCCH indicates a new DL multicast transmission for the MAC entity;
drx-LongCycleStartOffsetAI: the long DRX cycle drx-LongCycle-AI and drx-StartOffset-AI which defines the subframe where the long DRX cycle starts;
drx-RetransmissionTimerDL-AI (per DL HARQ process): the maximum duration until an AI model retransmission is received;
drx-HARQ-RTT-TimerDL-AI (per DL HARQ process): the minimum duration before an AI model assignment for HARQ retransmission is expected by the MAC entity.

Continue to refer to FIG. 5, the terminal device 110 may perform 520, based on the DRX configuration, PDCCH monitoring for reception of the information of the AI model.

In some embodiments, the terminal device 110 may monitor, in active time specific to the information of the AI model, a PDCCH with cyclic redundancy check (CRC) scrambled by an RNTI specific to the information of the AI model. In other words, an RNTI specific to the AI model information is introduced. If delivery of AI model information is activated, the terminal device 110 may monitor PDCCH with CRC scrambled by the RNTI during the active time specific to the AI model information.

In some embodiments, the active time specific to the AI model information may comprise drx-onDuration TimerAI or drx-Inactivity TimerAI or drx-RetransmissionTimerDL-AI for the RNTI specific to the AI model information.

Continue to refer to FIG. 5, the network device 120 may transmit 530, to the terminal device 110, a MAC CE specific to the information of the AI model. In this case, the terminal device 110 may stop 540 a timer related to the active time specific to the information of the AI model. That means that delivery of AI model information is finished.

For illustration, an example procedure may be described as below.

For AI model transfer, the MAC entity may be configured by RRC with a DRX functionality (for AI model, data set transfer) that controls the UE's PDCCH monitoring activity for the MAC entity's AI/ML-RNTI, AI/ML-CS-RNTI.
RRC controls AI specific DRX operation based on the parameters (listed in configuration part);
if [(SFN×10)+subframe number] modulo (drx-LongCycle-AI)=drx-StartOffset-AI, start drx-onDuration TimerAI after drx-SlotOffsetAI from the beginning of the subframe;
if the MAC entity is in Active Time for AI/ML-RNTI or AI/ML-CS-RNTI, monitor PDCCH for this RNTI;
if the PDCCH indicates a DL transmission or MAC PDU is received in a configured downlink AI assignment, process the HARQ procedure based on drx-HARQ-RTT-TimerDL-AI, drx-RetransmissionTimerDL-AI as legacy mechanism;
if the PDCCH indicates a new AI model transmission for this AI/ML-RNTI or AI/ML-CS-RNTI, start or restart drx-InactivityTimerAI in the first symbol after the end of the PDCCH reception.
if an AI DRX Command MAC CE with DCI scrambled with an AI/ML-RNTI or AI/ML-CS-RNTI is received, stop drx-onDurationTimerAI of the DRX for this RNTI and stop drx-Inactivity TimerAI of the DRX for this RNTI.

With the process 500, DRX of AI model information may be achieved. The impact on the conventional DRX function may be avoided, and unnecessary PDCCH blind detection may be reduced.

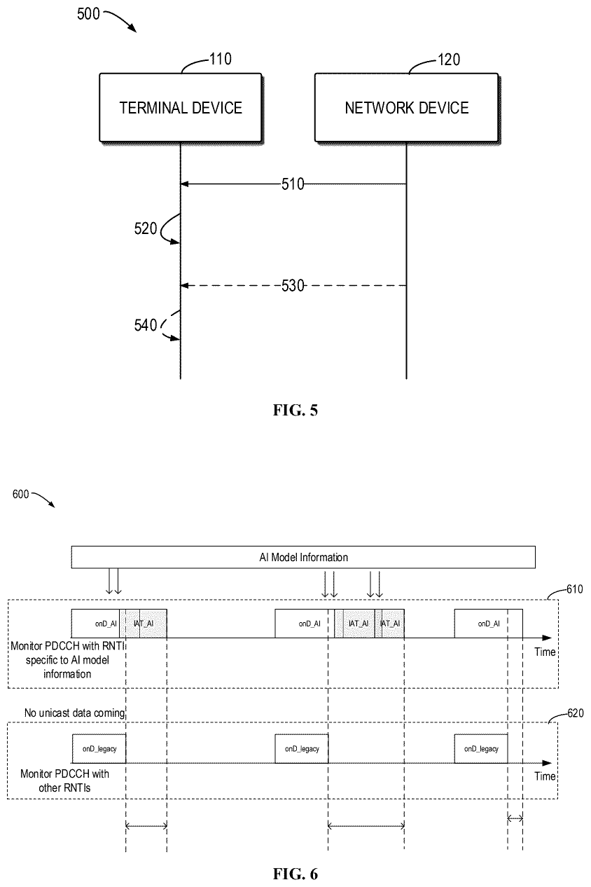

FIG. 6 illustrates a schematic diagram 600 illustrating an example DRX function according to embodiments of the present disclosure. As shown in FIG. 6, a DRX function 610 specific to AI model information and a DRX function 620 for transmission other than AI model information delivery are enabled simultaneously. For the DRX function 610, the terminal device may monitor a PDCCH with an RNTI specific to the AI model information on active time of the DRX function 610. For the DRX function 620, the terminal device may monitor a PDCCH with an RNTI different from the RNTI specific to the AI model information on active time of the DRX function 620.

As shown in FIG. 6, if there is no unicast data coming, the terminal device may only monitor a PDCCH with an RNTI specific to the AI model information, and may not monitor a PDCCH with other RNTIs. In the example of FIG. 6, onD_AI denotes start of an on-duration timer for AI model delivery, IAT_AI denotes start of an inactivity timer for AI model delivery, and onD_legacy denotes start of an on-duration timer for unicast data transmission.

So far, solutions for delivery of AI model information are described with reference to the processes 300 to 500. It is to be understood that the processes 300 to 500 may be performed separately or in any suitable combination.

### Example Implementation of Methods

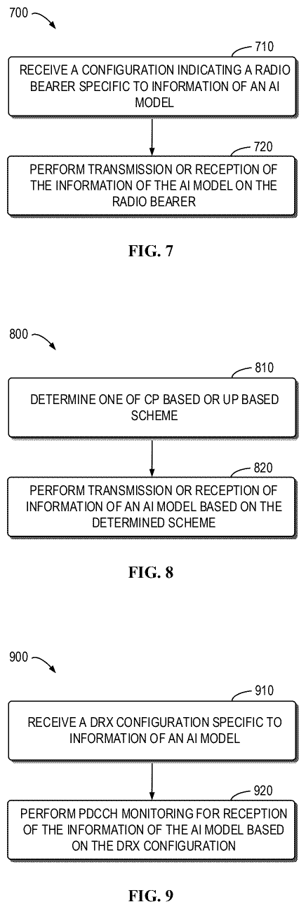

Corresponding to the above processes, embodiments of the present disclosure provide methods of communication implemented at a terminal device. These methods will be described below with reference to FIGS. 7 to 9.

FIG. 7 illustrates an example method 700 of communication implemented at a terminal device in accordance with some embodiments of the present disclosure. For example, the method 700 may be performed at the terminal device 110 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

At block 710, the terminal device 110 receives, from the network device 120, a configuration indicating a radio bearer specific to information of an AI model. In some embodiments, the information of the AI model may comprise at least one of the following: the AI model, or a data set for the AI model.

In some embodiments, the radio bear is associated with at least one of the following: an identity of the AI model, a function of the AI model, or an identity of a data set for the AI model. In this way, a dedicated radio bear may be provided for model delivery.

At block 720, the terminal device 110 performs transmission or reception of the information of the AI model on the radio bearer.

In some embodiments where the radio bearer is a SRB, the terminal device 110 may perform the reception of the information of the AI model. In some embodiments, the terminal device 110 may receive, from the network device 120, a first message comprising a first segment of the information of the AI model. If the first message comprises a request for confirmation for reception of the first segment, the terminal device 110 may transmit, to the network device 120, a first indication that the first segment has been received. In this way, correct reception of each segment may be ensured.

In some embodiments, the first indication may comprise at least one of the following: a sequence number of the first segment, or a size of a transferred portion of the information of the AI model. In some embodiments, the first message may further comprise the size of the transferred portion of the information of the AI model. In this way, more assistance information may be provided for a terminal device to check the situation of model delivery.

In some embodiments, the terminal device 110 may determine, based on a sequence number of the first segment and a sequence number of a second segment that has been received before the first segment, that a third segment is missing. In this case, the terminal device 110 may transmit, to the network device 120, a second indication that the third segment is missing. In this way, missing segments may be reported to a network side.

In some embodiments, the first message may be associated with at least one of the following: an identity of the AI model, a function of the AI model, or an identity of a data set for the AI model. In this way, a dedicated message may be provided for model delivery.

In some embodiments where the radio bearer is a SRB, the terminal device 110 may perform the transmission of the information of the AI model. In some embodiments, the terminal device 110 may transmit, to the network device 120, a second message comprising a fourth segment of the information of the AI model. If the second message comprises a request for confirmation for reception of the fourth segment, the terminal device 110 may receive, from the network device 120, a third indication that the fourth segment has been received. In this way, correct transmission of each segment may be ensured.

In some embodiments, the third indication may comprise at least one of the following: a sequence number of the fourth segment, or a size of a transferred portion of the information of the AI model.

In some embodiments, the second message further comprises the size of the transferred portion of the information of the AI model. In this way, more assistance information may be provided for a network to check the situation of model delivery.

In some embodiments, the terminal device 110 may receive, from the network device 120, a fourth indication that a fifth segment is missing. In this way, correct segment transmission may be facilitated.

In some embodiments, if the second message is transmitted, the terminal device 110 may start a timer. If the third indication is received, the terminal device 110 may stop the timer. If the timer expiries, the terminal device 110 may stop transmission of the information of the AI model.

In some embodiments, the second message may be associated with at least one of the following: an identity of the AI model, a function of the AI model, or an identity of a data set for the AI model.

In some embodiments where the radio bearer is a DRB, the terminal device 110 may receive, from the network device 120, an indication that the radio bearer is used for transmission or reception of the information of the AI model associated with a RAN. In this way, an explicit indication may be provided. In some embodiments, if a SDAP configuration is absent, the terminal device 110 may determine that the radio bearer is used for transmission or reception of the information of the AI model associated with the RAN. If the SDAP configuration is present or the SDAP configuration is empty, the terminal device 110 may determine that the radio bearer is used for transmission or reception of the information of the AI model associated with a CN. In this way, an implicit indication may be provided.

With the method 700, delivery of AI model information in CP or UP may be enhanced.

FIG. 8 illustrates another example method 800 of communication implemented at a terminal device in accordance with some embodiments of the present disclosure. For example, the method 800 may be performed at the terminal device 110 as shown in FIG. 1. For the purpose of discussion, in the following, the method 800 will be described with reference to FIG. 1. It is to be understood that the method 800 may include additional blocks not shown and/or may omit some blocks as shown, and the scope of the present disclosure is not limited in this regard.

At block 810, the terminal device 110 determines one of a CP based scheme and a UP based scheme for transmission or reception of information of an AI model.

In some embodiments, the terminal device 110 may determine the one of the CP based scheme and the UP based scheme based on a criterion. In some embodiments, if a size of the information of the AI model is above a threshold size, the terminal device 110 may select the UP based scheme for transmission of the information of the AI model. If the size of the information of the AI model is below the threshold size, the terminal device 110 may select the CP based scheme for transmission of the information of the AI model. In some embodiments, if a number of parameters for the AI model is above a threshold number, the terminal device 110 may select the UP based scheme for transmission of the information of the AI model. If the number of parameters for the AI model is below the threshold number, the terminal device 110 may select the CP based scheme for transmission of the information of the AI mode. In some embodiments, the terminal device 110 may select, from a mapping between functions of AI models and schemes, the one of the CP based scheme and the UP based scheme corresponding to a function of the AI model.

In some embodiments, the terminal device 110 may receive, from the network device 120, a message for enquiring whether a CP based scheme or a UP based scheme is used for transmission of the information of the AI model. In this case, the terminal device 110 may transmit, to the network device 120, information of the determined one of the CP based scheme and the UP based scheme.

In some embodiments, the terminal device 110 may transmit, to the network device 120, a message for enquiring whether a CP based scheme or a UP based scheme is used for transmission of the information of the AI model, and receive, from the network device 120, information of the determined one of the CP based scheme and the UP based scheme.

In some embodiments, the transmitted or received message may comprise at least one of the following: a size of the information of the AI model, a number of parameters for the AI model, a mapping between functions of AI models and schemes, an expected scheme for transmission of the information of the AI model, a priority of the information of the AI model, latency of the transmission of the information of the AI model, or a number of AI models.

At block 820, the terminal device 110 performs the transmission or reception of the information of the AI model based on the determined one of the CP based scheme and the UP based scheme.

With the method 800, a CP or UP scheme for delivery of AI model information may be selected.

FIG. 9 illustrates still another example method 900 of communication implemented at a terminal device in accordance with some embodiments of the present disclosure. For example, the method 900 may be performed at the terminal device 110 as shown in FIG. 1. For the purpose of discussion, in the following, the method 900 will be described with reference to FIG. 1. It is to be understood that the method 900 may include additional blocks not shown and/or may omit some blocks as shown, and the scope of the present disclosure is not limited in this regard.

At block 910, the terminal device 110 receives, from the network device 120, a DRX configuration specific to information of an AI model.

At block 920, the terminal device 110 performs, based on the DRX configuration, PDCCH monitoring for reception of the information of the AI model. In some embodiments, the terminal device 110 may monitor, in active time specific to the information of the AI model, a PDCCH with CRC scrambled by an RNTI specific to the information of the AI model.

In some embodiments, the terminal device 110 may receive, from the network device 120, a MAC CE specific to the information of the AI model. Based on the reception of the MAC CE, the terminal device 110 may stop a timer related to active time specific to the information of the AI model.

With the method 900, a DRX function specific to model delivery may be provided separately with a DRX function for other data or signaling transmissions.

It is to be understood that operations of the methods 700 to 900 correspond to that described in connection with FIGS. 3 to 5, and thus other details are not repeated here for concise.

### Example Implementation of Device and Apparatus

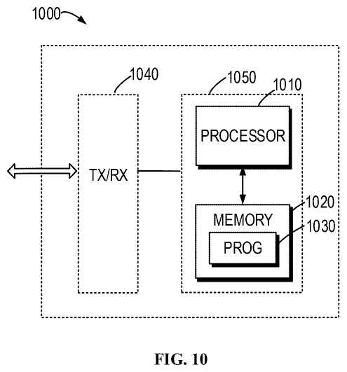

FIG. 10 is a simplified block diagram of a device 1000 that is suitable for implementing embodiments of the present disclosure. The device 1000 can be considered as a further example implementation of the terminal device 110 or 111 or the network device 120 as shown in FIG. 1. Accordingly, the device 1000 can be implemented at or as at least a part of the terminal device 110 or the network device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1010 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1030 is assumed to include program instructions that, when executed by the associated processor 1010, enable the device 1000 to operate in accordance with the embodiments of the present disclosure, as discussed herein with reference to FIGS. 1 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 1050 adapted to implement various embodiments of the present disclosure.

The memory 1020 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises a circuitry configured to: receive, from a network device, a configuration indicating a radio bearer specific to information of an artificial intelligence (AI) model; and perform transmission or reception of the information of the AI model on the radio bearer.

In some embodiments, a terminal device comprises a circuitry configured to: determine one of a control plane (CP) based scheme and a user plane (UP) based scheme for transmission or reception of information of an artificial intelligence (AI) model; and perform the transmission or reception of the information of the AI model based on the determined one of the CP based scheme and the UP based scheme.

In some embodiments, a terminal device comprises a circuitry configured to: receive, from a network device, a discontinuous reception (DRX) configuration specific to information of an artificial intelligence (AI) model; and perform, based on the DRX configuration, physical downlink control channel (PDCCH) monitoring for reception of the information of the AI model.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure provide the following solutions.

In one solution, a terminal device comprises a processor configured to cause the terminal device to: receive, from a network device, a configuration indicating a radio bearer specific to information of an artificial intelligence (AI) model; and perform transmission or reception of the information of the AI model on the radio bearer.

In some embodiments, the radio bearer is a signal radio bearer, and the terminal device is further caused to perform the reception of the information of the AI model by: receiving, from the network device, a first message comprising a first segment of the information of the AI model; and in accordance with a determination that the first message comprises a request for confirmation for reception of the first segment, transmitting, to the network device, a first indication that the first segment has been received.

In some embodiments, the first indication comprises at least one of the following: a sequence number of the first segment, or a size of a transferred portion of the information of the AI model.

In some embodiments, the first message further comprises the size of the transferred portion of the information of the AI model.

In some embodiments, the terminal device is further caused to: determine, based on a sequence number of the first segment and a sequence number of a second segment that has been received before the first segment, that a third segment is missing; and transmit, to the network device, a second indication that the third segment is missing.

In some embodiments, the first message is associated with at least one of the following: an identity of the AI model, a function of the AI model, or an identity of a data set for the AI model.

In some embodiments, the radio bearer is a signal radio bearer, and the terminal device is further caused to perform the transmission of the information of the AI model by: transmitting, to the network device, a second message comprising a fourth segment of the information of the AI model; and in accordance with a determination that the second message comprises a request for confirmation for reception of the fourth segment, receiving, from the network device, a third indication that the fourth segment has been received.

In some embodiments, the third indication comprises at least one of the following: a sequence number of the fourth segment, or a size of a transferred portion of the information of the AI model.

In some embodiments, the second message further comprises the size of the transferred portion of the information of the AI model.

In some embodiments, the terminal device is further caused to: receive, from the network device, a fourth indication that a fifth segment is missing.

In some embodiments, the terminal device is further caused to at least one of the following: in accordance with a determination that the second message is transmitted, start a timer; in accordance with a determination that the third indication is received, stop the timer; or in accordance with a determination that the timer expiries, stop transmission of the information of the AI model.

In some embodiments, the second message is associated with at least one of the following: an identity of the AI model, a function of the AI model, or an identity of a data set for the AI model.

In some embodiments, the radio bearer is a data radio bearer, and the terminal device is further caused to at least one of the following: receive, from the network device, an indication that the radio bearer is used for transmission or reception of the information of the AI model associated with a radio access network; in accordance with a determination that a service data adaptation protocol (SDAP) configuration is absent, determine that the radio bearer is used for transmission or reception of the information of the AI model associated with the radio access network; or in accordance with a determination that the SDAP configuration is present or the SDAP configuration is empty, determine that the radio bearer is used for transmission or reception of the information of the AI model associated with a core network.

In some embodiments, the information of the AI model comprises at least one of the following: the AI model, or a data set for the AI model.

In some embodiments, the radio bear is associated with at least one of the following: an identity of the AI model, a function of the AI model, or an identity of a data set for the AI model.

In another solution, a terminal device comprises a processor configured to cause the terminal device to: determine one of a control plane (CP) based scheme and a user plane (UP) based scheme for transmission or reception of information of an artificial intelligence (AI) model; and perform the transmission or reception of the information of the AI model based on the determined one of the CP based scheme and the UP based scheme.

In some embodiments, the terminal device is caused to determine the one of the CP based scheme and the UP based scheme by: receiving, from a network device, a message for enquiring whether the CP based scheme or the UP based scheme is used for transmission of the information of the AI model; and transmitting, to the network device, information of the determined one of the CP based scheme and the UP based scheme.

In some embodiments, the terminal device is caused to determine the one of the CP based scheme and the UP based scheme by: transmitting, to a network device, a message for enquiring whether the CP based scheme or the UP based scheme is used for transmission of the information of the AI model; and receiving, from the network device, information of the determined one of the CP based scheme and the UP based scheme.

In some embodiments, the message comprises at least one of the following: a size of the information of the AI model, number of parameters for the AI model, a mapping between functions of AI models and schemes, an expected scheme for transmission of the information of the AI model, a priority of the information of the AI model, latency of the transmission of the information of the AI model, or number of AI models.

In some embodiments, the terminal device is caused to determine the one of the CP based scheme and the UP based scheme by: in accordance with a determination that a size of the information of the AI model is above a threshold size, selecting the UP based scheme for transmission of the information of the AI model; in accordance with a determination that the size of the information of the AI model is below the threshold size, selecting the CP based scheme for transmission of the information of the AI model; in accordance with a determination that a number of parameters for the AI model is above a threshold number, selecting the UP based scheme for transmission of the information of the AI model; in accordance with a determination that the number of parameters for the AI model is below the threshold number, selecting the CP based scheme for transmission of the information of the AI model; or selecting, from a mapping between functions of AI models and schemes, the one of the CP based scheme and the UP based scheme corresponding to a function of the AI model.

In another solution, a terminal device comprises a processor configured to cause the terminal device to: receive, from a network device, a discontinuous reception (DRX) configuration specific to information of an artificial intelligence (AI) model; and perform, based on the DRX configuration, physical downlink control channel (PDCCH) monitoring for reception of the information of the AI model.

In some embodiments, the terminal device is caused to perform the PDCCH monitoring by: monitoring, in active time specific to the information of the AI model, a PDCCH with cyclic redundancy check (CRC) scrambled by a radio network temporary identity (RNTI) specific to the information of the AI model.

In some embodiments, the terminal device is further caused to: receive, from the network device, a medium access control control element (MAC CE) specific to the information of the AI model; and stop a timer related to active time specific to the information of the AI model.

In another solution, a method of communication comprises: receiving, at a terminal device and from a network device, a configuration indicating a radio bearer specific to information of an artificial intelligence (AI) model; and performing transmission or reception of the information of the AI model on the radio bearer.

In another solution, a method of communication comprises: determining, at a terminal device, one of a control plane (CP) based scheme and a user plane (UP) based scheme for transmission or reception of information of an artificial intelligence (AI) model; and performing the transmission or reception of the information of the AI model based on the determined one of the CP based scheme and the UP based scheme.

In another solution, a method of communication comprises: receiving, at a terminal device and from a network device, a discontinuous reception (DRX) configuration specific to information of an artificial intelligence (AI) model; and performing, based on the DRX configuration, physical downlink control channel (PDCCH) monitoring for reception of the information of the AI model.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device, comprising:
a processor configured to cause the terminal device to:
receive, from a network device, a configuration indicating a radio bearer specific to information of an artificial intelligence (AI) model; and
perform transmission or reception of the information of the AI model on the radio bearer.

2. The terminal device of claim 1, wherein the radio bearer is a signal radio bearer, and wherein the terminal device is further caused to perform the reception of the information of the AI model by:
receiving, from the network device, a first message comprising a first segment of the information of the AI model; and
in accordance with a determination that the first message comprises a request for confirmation for reception of the first segment, transmitting, to the network device, a first indication that the first segment has been received.

3. The terminal device of claim 2, wherein the first indication comprises at least one of the following:
a sequence number of the first segment, or
a size of a transferred portion of the information of the AI model.

4. The terminal device of claim 2, wherein the terminal device is further caused to:
determine, based on a sequence number of the first segment and a sequence number of a second segment that has been received before the first segment, that a third segment is missing; and
transmit, to the network device, a second indication that the third segment is missing.

5. The terminal device of claim 2, wherein the first message is associated with at least one of the following:
an identity of the AI model,
a function of the AI model, or
an identity of a data set for the AI model.

6. The terminal device of claim 1, wherein the radio bearer is a signal radio bearer, and wherein the terminal device is further caused to perform the transmission of the information of the AI model by:
transmitting, to the network device, a second message comprising a fourth segment of the information of the AI model; and
in accordance with a determination that the second message comprises a request for confirmation for reception of the fourth segment, receiving, from the network device, a third indication that the fourth segment has been received.

7. The terminal device of claim 6, wherein the third indication comprises at least one of the following:
a sequence number of the fourth segment, or
a size of a transferred portion of the information of the AI model.

8. The terminal device of claim 6, wherein the terminal device is further caused to:
receive, from the network device, a fourth indication that a fifth segment is missing.

9. The terminal device of claim 6, wherein the terminal device is further caused to at least one of the following:
in accordance with a determination that the second message is transmitted, start a timer;
in accordance with a determination that the third indication is received, stop the timer; or
in accordance with a determination that the timer expiries, stop transmission of the information of the AI model.

10. The terminal device of claim 6, wherein the second message is associated with at least one of the following:
an identity of the AI model,
a function of the AI model, or
an identity of a data set for the AI model.

11. The terminal device of claim 1, wherein the radio bearer is a data radio bearer, and wherein the terminal device is further caused to at least one of the following:
receive, from the network device, an indication that the radio bearer is used for transmission or reception of the information of the AI model associated with a radio access network;
in accordance with a determination that a service data adaptation protocol (SDAP) configuration is absent, determine that the radio bearer is used for transmission or reception of the information of the AI model associated with the radio access network; or
in accordance with a determination that the SDAP configuration is present or the SDAP configuration is empty, determine that the radio bearer is used for transmission or reception of the information of the AI model associated with a core network.

12. The terminal device of claim 1, wherein the information of the AI model comprises at least one of the following:
the AI model, or
a data set for the AI model.

13. The terminal device of claim 1, wherein the radio bear is associated with at least one of the following:
an identity of the AI model,
a function of the AI model, or
an identity of a data set for the AI model.

14. A terminal device, comprising:
a processor configured to cause the terminal device to:
determine one of a control plane (CP) based scheme and a user plane (UP) based scheme for transmission or reception of information of an artificial intelligence (AI) model; and
perform the transmission or reception of the information of the AI model based on the determined one of the CP based scheme and the UP based scheme.

15. The terminal device of claim 14, wherein the terminal device is caused to determine the one of the CP based scheme and the UP based scheme by:
receiving, from a network device, a message for enquiring whether the CP based scheme or the UP based scheme is used for transmission of the information of the AI model; and
transmitting, to the network device, information of the determined one of the CP based scheme and the UP based scheme.

16. The terminal device of claim 14, wherein the terminal device is caused to determine the one of the CP based scheme and the UP based scheme by:
transmitting, to a network device, a message for enquiring whether the CP based scheme or the UP based scheme is used for transmission of the information of the AI model; and
receiving, from the network device, information of the determined one of the CP based scheme and the UP based scheme.

17. The terminal device of claim 15 or 16, wherein the message comprises at least one of the following:
a size of the information of the AI model,
number of parameters for the AI model,
a mapping between functions of AI models and schemes,
an expected scheme for transmission of the information of the AI model,
a priority of the information of the AI model,
latency of the transmission of the information of the AI model, or
number of AI models.

18. The terminal device of claim 14, wherein the terminal device is caused to determine the one of the CP based scheme and the UP based scheme by:
in accordance with a determination that a size of the information of the AI model is above a threshold size, selecting the UP based scheme for transmission of the information of the AI model;
in accordance with a determination that the size of the information of the AI model is below the threshold size, selecting the CP based scheme for transmission of the information of the AI model;
in accordance with a determination that a number of parameters for the AI model is above a threshold number, selecting the UP based scheme for transmission of the information of the AI model;
in accordance with a determination that the number of parameters for the AI model is below the threshold number, selecting the CP based scheme for transmission of the information of the AI model; or
selecting, from a mapping between functions of AI models and schemes, the one of the CP based scheme and the UP based scheme corresponding to a function of the AI model.

19. A terminal device, comprising:
a processor configured to cause the terminal device to:
receive, from a network device, a discontinuous reception (DRX) configuration specific to information of an artificial intelligence (AI) model; and
perform, based on the DRX configuration, physical downlink control channel (PDCCH) monitoring for reception of the information of the AI model.

20. The terminal device of claim 19, wherein the terminal device is caused to perform the PDCCH monitoring by:
monitoring, in active time specific to the information of the AI model, a PDCCH with cyclic redundancy check (CRC) scrambled by a radio network temporary identity (RNTI) specific to the information of the AI model.
